(19) United States
(12) Patent Application Publication
(10) Pub. No.: US 2023/0380586 A1
(43) Pub. Date: Nov. 30, 2023

(54) Keyboard Korrector

(71) Applicant: Tracy Aguayo, Clark, SD (US)

(72) Inventor: Tracy Aguayo, Clark, SD (US)

(21) Appl. No.: 18/321,027

(22) Filed: May 22, 2023

Related U.S. Application Data
(60) Provisional application No. 63/345,681, filed on May 25, 2022.

(51) Int. Cl. A47B 21/04; F16B 1/00

(52) U.S. Cl. CPC A47B 21/04; F16B 1/00; F16B 2001/0028

(57) ABSTRACT

A support stand for portable devices is formed as an integral unit with a bend between a proximal end and a distal end. Embodiments of the stand comprise an apparatus that measures approximately 1.5″ wide and 4.25″ long and is all one piece. The stand has a bend about 1″ from a proximal end of the apparatus resulting in the remaining length being about 3.25″ from the bend to a distal end of the apparatus. The approximate height of the apparatus from any surface to the top of the bend is about ⅞″. Adhesive is installed on the top of the apparatus which can be affixed to any device to raise it from a flat surface to an ergonomically correct height. The apparatus raises the user's device to that ergonomically correct height partially because the bend has an angle between approximately 15° and approximately 23°.

### CROSS-REFERENCE TO RELATED APPLICATIONS

This application claims the benefit of provisional patent application No. 63/345,681, filed on May 25, 2022.

### BACKGROUND OF THE INVENTION

Portable computing devices, such as keyboards, laptops, notebooks, tablets, and cell phones, have become integral to everyday life. Books and notepads also continue to be commonly used. The size of these devices varies greatly. However, each of these devices are generally designed to lay flat on a table or surface. While that design promotes portability, it fails to permit the user to use the device at an ergonomically appropriate height. People who use these devices may regularly be plagued by illnesses such as body fatigue, muscle stiffness, tendonitis, and even arthritis in their arms and hands. Staring down into the device, rather than straight ahead, can cause similar problems in users' necks, shoulders, and backs.

### BRIEF SUMMARY OF THE INVENTION

This invention contemplates a portable, detachable support stand apparatus and a method of using the same. The apparatus can be removably attached to a bottom side of a user's device, raising the device to an ergonomically correct height, measured from a surface to a top of a device or unit because the bend has an angle which ranges from around 15° to around 23°. The apparatus can be removably attached to any device or object that a user wishes to prop up at an ergonomically healthy angle, such as keyboards, laptops, notebooks, tablets, notepads, and books. Specific embodiments contemplate removably attaching the apparatus with a piece of hook and loop adhesive tape, or other adhesive, installed along the support surface of the apparatus and affixed to the bottom side of the user's keyboard, laptop, cellphone, notebook, tablets or other device, object, or unit.

### BRIEF DESCRIPTION OF THE DRAWINGS

FIG. 1 is a side view of a support stand in accordance with embodiments of this invention;

FIG. 2 is a perspective view of a support stand in accordance with embodiments of this invention;

FIG. 3 is a top view of a support stand in accordance with embodiments of this invention;

FIG. 4 is a perspective view of a support stand in accordance with embodiments of this invention; and

FIG. 5 is a side view of a support stand in accordance with embodiments of this invention.

### DETAILED DESCRIPTION OF THE INVENTION

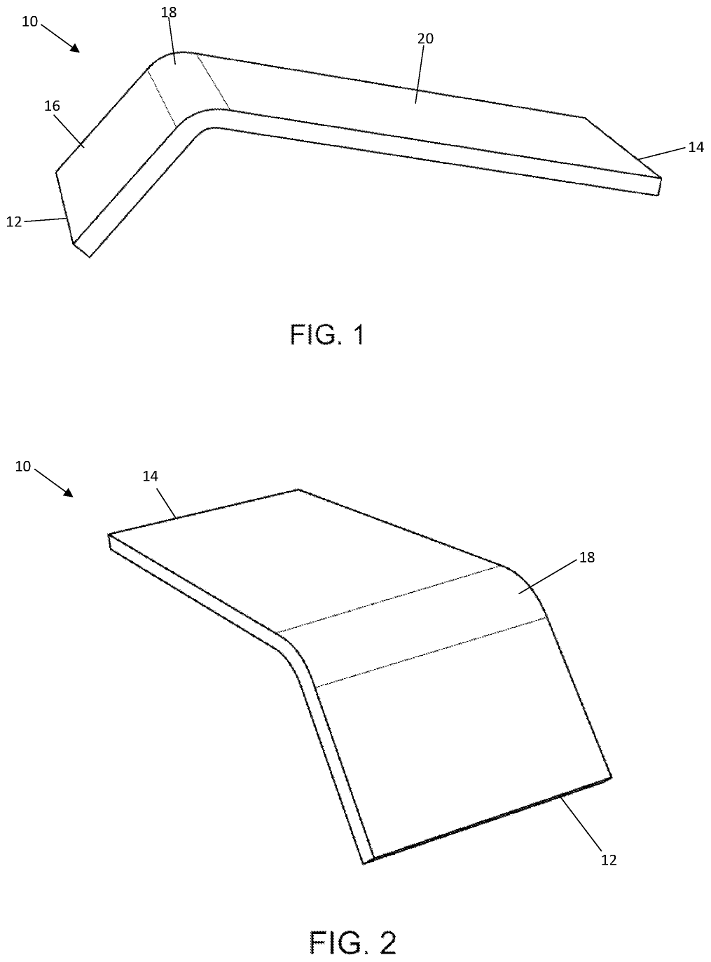

Referring now to the Drawings, a support stand apparatus according to an embodiment of this invention is generally shown in FIG. 1. The support stand apparatus 10 is generally comprised of a finished, one-piece product with a bend 18 between a proximal end 12 and a distal end 14. The bend 18 is closer to the proximal end 12. A leg 16 is between the proximal end 12 and the bend 18. The leg 16 is a generally flat surface. In one embodiment, the leg 16 is fashioned so that the proximal end 12 is approximately one inch (1″) from the apex of the bend 18. A support surface 20 is between the bend 18 and the distal end 14. The support surface 20 is a generally flat surface. In one example embodiment, the support surface 20 extends approximately three and one quarter inches (3.25″) from the bend 18 to the distal end 14. Embodiments may also be identified because the approximate angle of the bend 18 ranges from approximately 17° to approximately 21°. In other embodiments, the approximate angle of the bend 18 may range from approximately 15° to approximately 23°. Having the bend 18 at those approximate angles ensures that embodiments can lift a user's device to the appropriate, ergonomically optimal angle from a flat surface such as a tabletop. In other words, the angle of the bend 18 and the shape of the apparatus 10 work together to raise a user's objects from the flat surface or tabletop to a more comfortable position so that the user can type, write, read, or otherwise use those objects in a healthier manner that causes less strain on the user's muscles.

FIG. 2 provides a perspective view of the apparatus 10. As shown, the apparatus 10 can rest stably on a surface which contacts the proximal end 12 and the distal end 14. In that position, certain embodiments are identifiable because the approximate height of the apparatus 10 from that surface to the top of the bend 18 is about seven-eighths inch (⅞″).

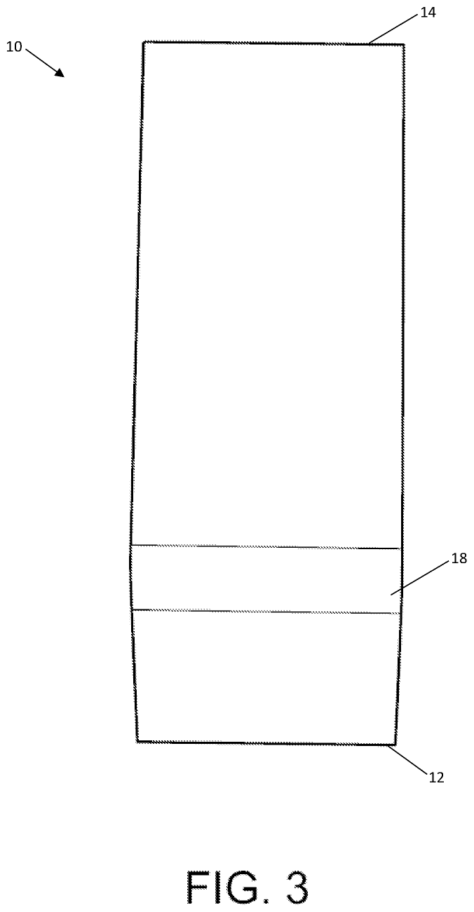

FIG. 3 provides a top-down view of the apparatus 10. As shown, embodiments may be generally rectangular. Embodiments may measure approximately one and a half inches (1.5″) wide and four and one-quarter inches (4.25″) long. In such embodiments, the length is measured from the proximal end 12 to the distal end 14. Alternative embodiments may have different dimensions, and the dimensions described and shown are for illustrative purposes only. The apparatus 10 is designed to be relatively small and easily portable. Embodiments are intended to be removably attached to commonly used devices, which may be as small as a cellular telephone or as large as a laptop computer. Some embodiments may therefore have smaller width and length dimensions which maintain the approximate height of the apparatus 10 from any surface on which the apparatus 10 rests to the top of the bend 18. As described above, preferred embodiments will maintain that height of approximately seven-eighths of an inch (⅞″).

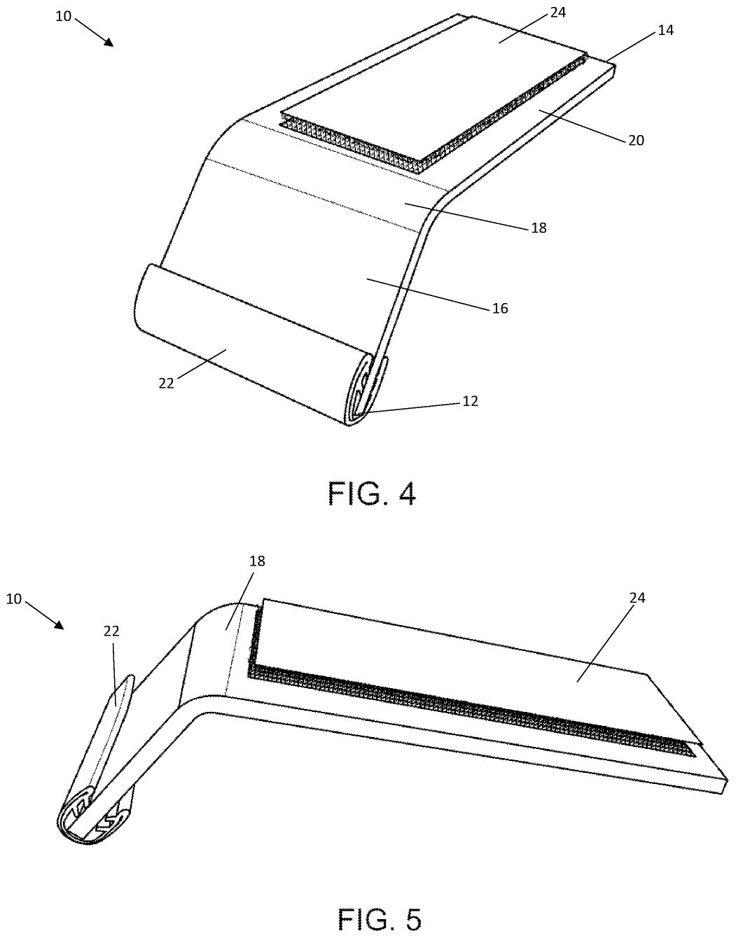

FIGS. 4 and 5 provide views of an alternative embodiment. In these embodiments, a foot 22 wraps around the proximal end 12. As shown, the foot 22 only extends over a portion of the leg 16. In alternative embodiments, the foot 22 may extend to cover more or less of the leg 16. The foot 22 stabilizes the apparatus 10 so that it does not slip across the resting surface under the weight of the user's device. In some embodiments, the foot 22 may be formed of a rubber or plastic composite and is fixed to the leg 16 at the proximal end 12. In alternative embodiments, the foot 22 may be integrally formed with the apparatus 10, for example by forming the entire apparatus 10 from a rubber or plastic composite.

An adhesive 24 is attached to the top of the support surface 20. In some embodiments, the adhesive 24 may comprise a piece of VELCRO® adhesive or other hook and loop adhesive tape. In other embodiments, the adhesive may comprise a magnet or other removable attachment mechanism. A complementary side of the adhesive 24 can also be attached to the under-side of the user's device which they wish to raise to an ergonomically appropriate height. Once the adhesive 24 is attached to the apparatus 10 and the user's device, the apparatus 10 can repeatedly be attached to and removed from the user's device. For example, a user could affix small pieces of a hook and loop adhesive tape to numerous devices or objects and temporarily affix the apparatus 10 to each of those devices or objects. In one scenario, the user could temporarily attach the apparatus 10 to their cell phone, remove the apparatus 10, and then attach the apparatus 10 to their book.

In certain embodiments, two or more apparatuses 10 can be used in tandem. For example, to prop up a keyboard, laptop computer or other larger device, two or more small pieces of hook and loop adhesive tape can be affixed to the under-side of the larger device, then a corresponding number of apparatuses 10 can be removably attached. Embodiments are small, lightweight, portable, and relatively inexpensive to manufacture so that users can adjust their use of the apparatus 10 to meet their varying needs or desires.

In the embodiments depicted in FIGS. 1-5, the apparatus 10 may be formed of an acrylic, plastic, or cut metal covered with powder coating. However, any durable, inflexible material may be used. Preferred embodiments present in shades of purple, but this disclosure is not intended to limit the invention to such embodiments. Embodiments of the apparatus 10 may comprise any combinations of colors or shades.

### Aspects of the Invention

A first aspect of the present invention comprises a kit for supporting an object comprising: a substantially rectilinear support stand having a distal end substantially contiguous to and opposite an elevated bend which is supported by a proximal end, wherein the approximate height of the elevated bend is about seven-eighths inches (⅞″) above the distal end, and further comprising a slip-resistant foot that wraps around and substantially covers the proximal end; and an adhesive that the user can attach to the rectilinear support stand, wherein the adhesive comprises a hook and loop adhesive tape.

A second aspect of the present invention comprises a method for supporting a personal device comprising: placing a first side of an adhesive on a support surface having a descendent distal end substantially contiguous to and opposite an elevated bend which is supported by a proximal end, wherein the bend is approximately seven-eighths inch (⅞″) above the descendent distal end; and a stabilizing foot fixed to the proximal end; placing a complementary second side of the adhesive on the personal device; and removably affixing the first side of the adhesive to the complementary second side of the adhesive.

A third aspect of the present invention comprises a removably mountable support stand for personal devices comprising: a substantially rectilinear support surface having a distal end substantially contiguous to and opposite an elevated bend which is supported by a proximal end, wherein the elevated bend is closer to the proximal end than the distal end, and wherein the approximate height of the elevated bend is about seven-eighths inch (⅞″) above the distal end, wherein the substantially rectilinear support surface is formed of a single, continuous piece of a durable and inflexible material; a stabilizing foot fixed to the proximal end, wherein the stabilizing foot is formed of a slip and scratch resistant material that covers substantially all of the proximal end; and a two-sided adhesive, wherein one side of the adhesive is affixed to the substantially rectilinear support surface and the second, complementary side of the adhesive is capable of being affixed to the personal device.

1) A removably mountable support stand for personal devices comprising:
a) A substantially rectilinear support surface having a distal end substantially contiguous to and opposite an elevated bend which is supported by a proximal end, wherein the elevated bend is closer to the proximal end than the distal end, and wherein the approximate height of the elevated bend is about seven-eighths inch (⅞″) above the distal end, wherein the substantially rectilinear support surface is formed of a single, continuous piece of a durable and inflexible material;
b) A stabilizing foot fixed to the proximal end, wherein the stabilizing foot is formed of a slip and scratch resistant material that covers substantially all of the proximal end; and
c) A two-sided adhesive, wherein one side of the adhesive is affixed to the substantially rectilinear support surface and the second, complementary side of the adhesive is capable of being affixed to the personal device.

2) The removably mountable support stand of claim 1, wherein the durable and inflexible material is acrylic.

3) The removably mountable support stand of claim 1, wherein the durable and inflexible material is plastic.

4) The removably mountable support stand of claim 1, wherein the durable and inflexible material is cut metal covered with a powder coating.

5) The removably mountable support stand of claim 1, wherein the elevated bend is approximately one inch (1″) away from the proximal end and approximately three and one-quarter inches (3¼″) away from the distal end.

6) The removably mountable support stand of claim 1, the elevated bend further comprising an angle, wherein the angle ranges from approximately 15° to approximately 23°.

7) The removably mountable support stand of claim 6, wherein the angle ranges from approximately 17° to approximately 21°.

8) The removably mountable support stand in claim 1, wherein the two-sided adhesive is a hook and loop adhesive tape.

9) The removably mountable support stand in claim 1, wherein the two-sided adhesive is a magnet.

10) The removably mountable support stand in claim 1, wherein the stabilizing foot is formed of a rubber or plastic composite.

11) A removably mountable support stand for personal devices comprising:
a) A substantially rectilinear support surface having a distal end substantially contiguous to and opposite an elevated bend which is supported by a proximal end, wherein the approximate height of the elevated bend is about seven-eighths inch (⅞″) above the distal end; and
b) A stabilizing foot fixed to the proximal end.

12) The removably mountable support stand of claim 11, wherein the rectilinear support surface is formed of a single, continuous piece of durable and inflexible material.

13) The removably mountable support stand of claim 12, wherein the material is acrylic.

14) The removably mountable support stand of claim 12, wherein the material is plastic.

15) The removably mountable support stand of claim 12, wherein the material is cut metal covered with a powder coating.

16) The removably mountable support stand of claim 11, wherein the stabilizing foot is formed of a non-slip and scratch resistant material.

17) The removably mountable support stand in claim 11, wherein the elevated bend is approximately one inch (1″) away from the proximal end and approximately three and one-quarter inches (3¼″) away from the distal end.

18) The removably mountable support stand in claim 11, further comprising:
a) A two-sided hook and loop adhesive, wherein a first side of the hook and loop adhesive is affixed on the support surface and a second side of the hook and loop adhesive is capable of being affixed to a personal device.

19) The removably mountable support stand in claim 11, wherein the stabilizing foot is formed of a rubber or plastic composite which covers substantially all of the proximal end.

20) The removably mountable support stand in claim 11, wherein the support surface is formed of a single continuous piece of a durable and inflexible material.
